(19) United States
(12) Patent Application Publication
(10) Pub. No.: US 2003/0101460 A1
(43) Pub. Date: May 29, 2003

(54) Video-on-demand system and method to reduce network bandwidth used thereby

(76) Inventor: Meng-Hsien Liu, Taoyuan (TW)

Correspondence Address: J.C. Patents, Inc., Suite 250, 4 Venture, Irvine, CA, 92618, US

(21) Appl. No.: 09/997,852

(22) Filed: Nov. 29, 2001

(51) Int. Cl. H04N 7/173

(52) U.S. Cl. 725/95; 725/96; 725/116

(57) ABSTRACT

Video-on-demand system and method to reduce bandwidth of user network, applied for reducing the bandwidth of a common video information received within a time interval for multiple users. When the time interval between the first user and the second user is within a certain range, the need for a common video information is determined. If a common video information is selected, the channel that the first user terminal receives the video information and the receiving time thereof are inspected. An unused channel of the second user terminal is used to output the video information received by the first user terminal within the receiving time as a front video information. Meanwhile, the video information that the first user terminal is recording is referred as the rear video information. After using the front video information, the second user terminal keeps using the recorded rear video information.

### BACKGROUND OF THE INVENTION

1. Field of the Invention

This invention relates in general to video on demand system and method, and more particularly, to video-on-demand system and method that reduce network bandwidth used thereby.

2. Description of the Related Art

As the optical fiber has been widely equipped in the telecommunication network and the techniques of broadband telecommunication network has rapidly advanced, the broadband service that has been provided worldwide by these telecommunication companies integrates communication, amusement and information services at the same network to satisfy the user's demand.

Due to the rapid advancement of broadband communication network, the style of passively receiving television programs at home has been replaced with ordering the television program without wasting time to watch commercials or boring programs. By simply notifying which television program or information is desired to watch, such program can be broadcast. This is so-called video-on-demand (VOD).

However, as the conventional VOD system consumes a great amount of network bandwidth while broadcasting video information, the amount of users and the quantity and speed of the information to be transmitted are limited. When many users within a certain time period are ordering the same program or film, a significant bandwidth will be occupied. For example, while 4 users are ordering a 4-hour film with a bandwidth of 4 Mbits/sec within a 1-hour time interval, a total bandwidth of 4 Mbit/sec*60 sec/min*60 min/hr*4 hr*4(users) is 230400 Mbs which are required to have all the users receive the film.

If the bandwidth required for allowing multiple users ordering the same information within a time interval is reduced, the quantity and speed for transmitting such information can be increased under a fixed bandwidth.

### SUMMARY OF THE INVENTION

The invention provides a video-on-demand system with a reduced network bandwidth used thereby. When multiple users are ordering the same information within a time interval, the bandwidth occupied by such information can be reduced.

The video-on-demand system comprises a video server, a display, and a set top box.

The video server is used to determine whether a common video information is selected by multiple users within a time interval. The display is built in each user terminal to output the selected video information. The set top box is installed in each user terminal and connected to the display, and is connected to the video server via the network. Each set top box further comprises a plurality of tuners.

When a second user terminal and a first user terminal receive a common video information within a time interval, the set top box of the second user terminal starts storing the video information that the first user terminal is receiving as a rear video information via a first tuner. Meanwhile, the video server also outputs the video information previously received by the first user terminal within the time interval to the second user terminal as a front video information so that a second tuner of the set top box of the second user terminal may continue outputting the rear video information to the display after outputting the front video information.

The invention further comprises a video-on-demand method that reduces the bandwidth of user network. Whether a common video information is selected by the first and the second user terminals within a time interval is determined. If a common video information is selected, the channel of communication network that the first user terminal uses to receive the video information and the time for receiving the video information are inspected. An unused channel of communication network of the first user terminal is used to output the video information received by the first user terminal within the receiving time as a front video information. Meanwhile, the second user terminal is recording a video information that the first user terminal is receiving as a rear video information. After receiving the front video information, the second user terminal continues using the recorded rear video information.

According, the invention reduces the bandwidth occupied by a common video information received by at least two user terminals within a time interval. The video information being received by the first user terminal is stored in the second user terminal, and the video information that has been received by the first user terminal within the time interval is sent to the second user terminal. After using the video information that the first user terminal has received within the time interval, the rear video information stored in the second user terminal can be kept so that the occupied bandwidth can be released earlier.

Both the foregoing general description and the following detailed description are exemplary and explanatory in nature only and are not bound or restricted the definition of the invention as claimed.

### BRIEF DESCRIPTION OF THE DRAWINGS

FIG. 1 shows an embodiment of a video-on-demand system;

FIG. 2 is a block diagram shows the internal of the set top box in FIG. 1;

FIG. 3 is a block diagram showing the details of the internal of the set top box;

FIG. 4 shows a process flow of a video on demand method in one embodiment of the invention; and

FIG. 5 shows at least two user terminals receiving a common video information within a time interval.

### DESCRIPTION OF THE PREFERRED EMBODIMENTS

The video server of the video-on-demand system and the user terminal are disposed at two different locations so that an appropriate communication network is required. Such communication network requires a large bandwidth to accommodate multiple channels for information or data transmission. In addition, to allow the user terminal to fully control broadcast of the video information, the communication network has to be able to transmit a inverted control signal. Whereas, to allow the video-on-demand system to operate normally, the video network has to transmit a large quantity of video programs downstream, and to transmit the full duplex communication network that control signal upstream. In the invention, a telephone line can also be used to select the data to be received. Therefore, the video-on-demand system does not have to be full duplex communication network.

The video-on-demand systems can be divided into three categories, including cable television video-on-demand system, computer network video-on-demand system, and an intermediate video-on-demand system.

The full analog video-on-demand system is basically developed for the application of cable television system. It is mainly applied to the cable television network to load and transmit new digital program signals, and to construct limited feedback network, so as to transmit a control signal via the feedback network. This is similar to a hybrid method with a good expandability of program bandwidth. However, as the speed of the feedback network of the cable television network is limited, the feedback of control command is affected when serving a large amount of users.

A pure video-on-demand system is basically a one-to-one service model. Although the structure thereof allows a one-to-multiple or multiple-to-multiple service model, the non-single-point service model is still restricted by the network structure with the current technique. As the video and control signals are transmitted via digital computer network, the requirement in network bandwidth is much more than normal network requirements.

The intermediate video-on-demand system is a mixture of the above two video-on-demand systems for information transmission. In the intermediate video on demand system, the video information is reserved in an analog form, while the control signal is transmitted via a digital network.

The demand in bandwidth in whichever video-on-demand system is the same. Therefore, the invention provides video-on-demand system and method with a reduced network bandwidth used thereby.

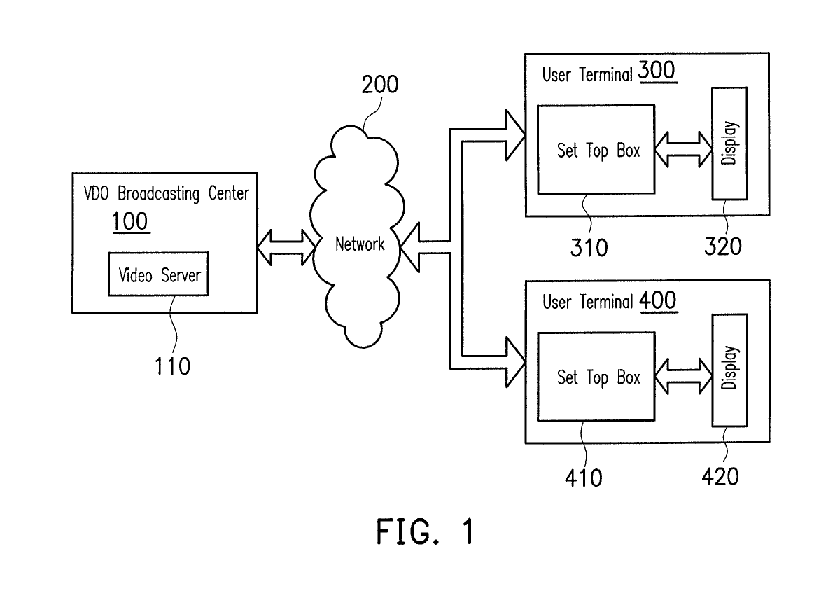

Referring to FIGS. 1, 2 and 3, an embodiment of a video-on-demand system with a reduced network bandwidth used thereby is illustrated. This video-on-demand system is applicable for multiple users to receive a common video information within a certain time interval.

In FIG. 1, the video-on-demand system with reduced network bandwidth of used network includes a video server 100, displays 320 and 420, and set top boxes 310 and 410.

The video server 110 responds the request of a user terminal at the video-on-demand broadcasting center 100, so as to output a video information selected by the user terminal within a time period. In addition, the video server 110 may also determine whether a common video information is selected at more than one user terminal within a certain time interval. The time interval indicates that some user terminals start receiving a common video information before the first user terminal finishes the reception of such video information.

The displays 320 and 420 are installed in each of the user terminals. For example, the display 320 is installed in the user terminal 300, and the display 420 is installed in the user terminal 400. Each of the displays 320 and 420 is used to output the video information selected by the user terminal. That is, via the display 320 or 420, the program or film selected by the user terminal is broadcast to the user to watch. Each of the display 320 and 420 includes a television or a computer system.

The set top box (STB) is also built in each of the user terminals and connected to the corresponding display. The set top box is also connected to the video server 110 via the communication network. As the communication network is divided into an analog network and a digital network, the set top box in the user terminal can receive the analog information sent from the analog network and display the analog information on the television. The set top box can also receive the digital information sent from the digital network and transmit it to the computer system. The digital information is then displayed on a computer screen.

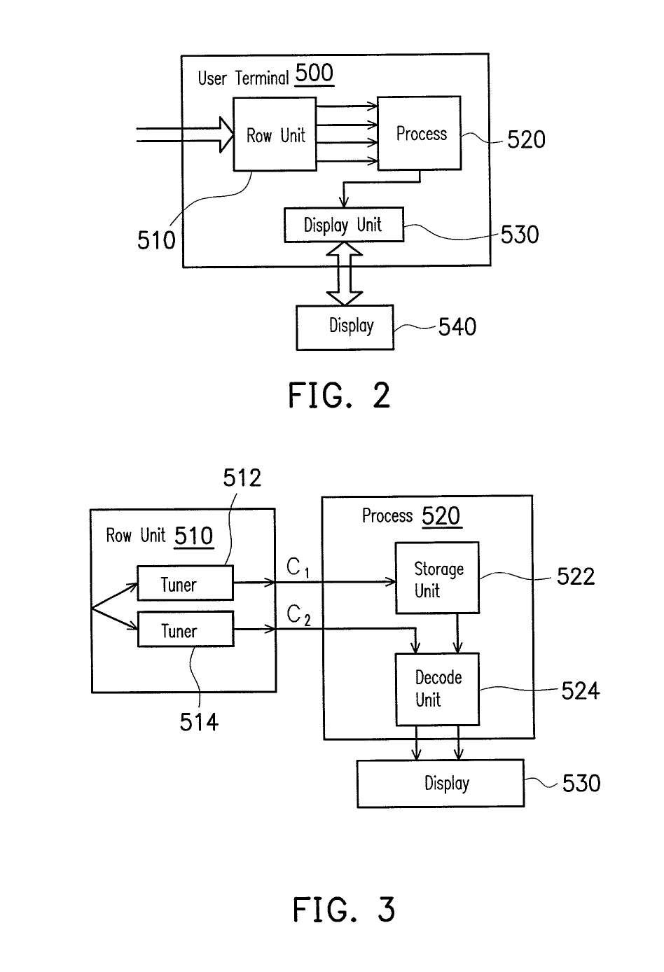

The above set top box includes the row unit 520, the process unit 530 and the display unit 540 as shown in FIG. 2.

The row unit 510 is connected to the video server 110 via the communication network to divide the video information transmitted by the video server 110 into a front video information and a rear video information. When any other user terminal selects the video information before the one that is currently receiving the video information, the video server 110 will recognize this as a ‘other user terminal.’ The video server 110 then notices this other user terminal to record. The row unit 510 includes a plurality of tuners (512 and 514 as shown in FIG. 3) to transmit the front video information and the rear video information to the process unit 520 connected to the row unit 510. The process unit 520 is used to output the front video information and to store the rear video information. The display unit is connected to the process unit 520 to output the previous or rear video information to the display means 540 for the audience to watch.

In FIG. 3, the process unit 520 includes a storage unit 522 and a decode unit 524.

The storage unit 522 is coupled to the row unit 510 to store the rear video information. The decode unit 524 is coupled to the row unit 510, the storage unit 522 and the display unit 524 to decode the previous and rear video information. Since the video information in the video server has been encoded, it has to be decoded before being output in the display unit 530.

In this embodiment, two user terminals receive a common video information within a time interval, therefore, only two tuners are illustrated. It is appreciated that the row unit 510 may include more than two tuners in practical application.

Assuming that the user terminal 400 receives a video information after the user terminal 300 has received the same video information for a time interval. The set top box 410 of the user terminal 400 starts using the storage unit 522 in the process unit 520 to receive the rear video information C2 that the user terminal 300 is receiving via the first tuner (such as the tuner 512 as shown in FIG. 3). The rear video information received within the time interval that the user terminal 300 receives is called the front video information C1, while the video information stored in the storage unit 522 that the user terminal 300 is currently receiving is called the rear video information C2.

At the time that the storage unit 522 of the user terminal 300 is receiving the rear video information, the video server 110 outputs the front video information C1 that the user terminal 300 receives within the time interval to the user terminal 400 via the second tuner (such as the tuner 514 in FIG. 3). Consequently, the set top box 410 at the user terminal 400 may continue outputting the post stored video information C2 to the display unit 540 after outputting the front video information C1 to the display unit 514. The bandwidth occupied by the video information received by the user terminals 300 and 400 is released in advance.

The video information received by each user terminal may include video information and audio information such as movies on demand (MOD), karaoke on demand (KOD), information on demand (IOD) provided by the video server 110 of the video on demand display center 100. When the user terminal selects the desired video information, a control signal is transmitted to inform the video server 110 what kind of information to be provided to the user terminal. The control signal can be provided by the telephone speech. Alternatively, a remote control may be applied for the selection.

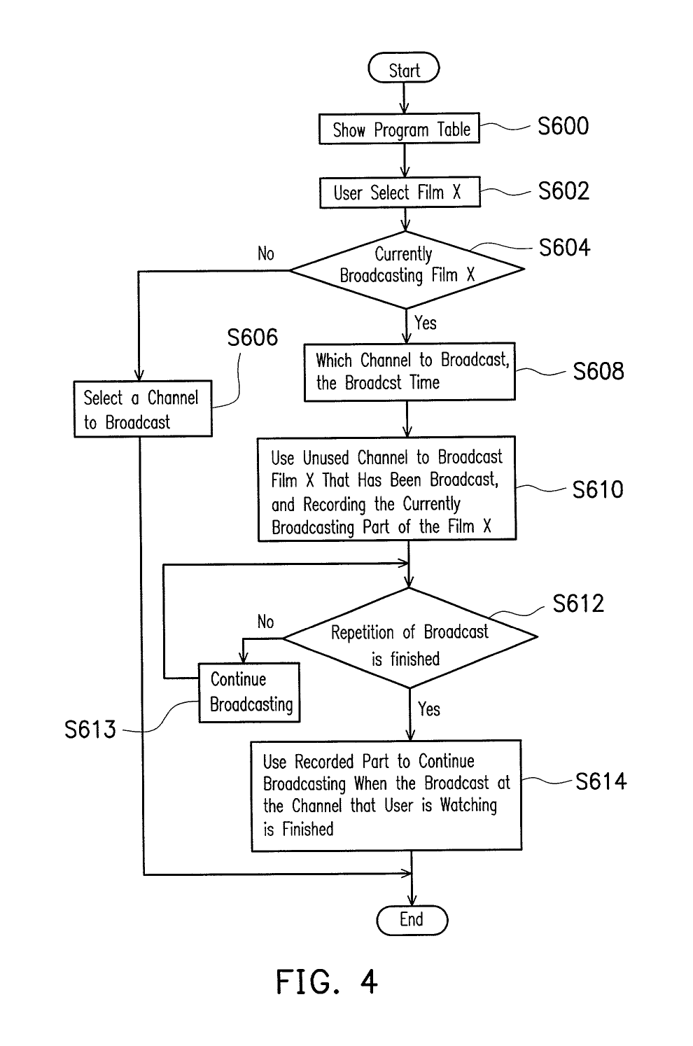

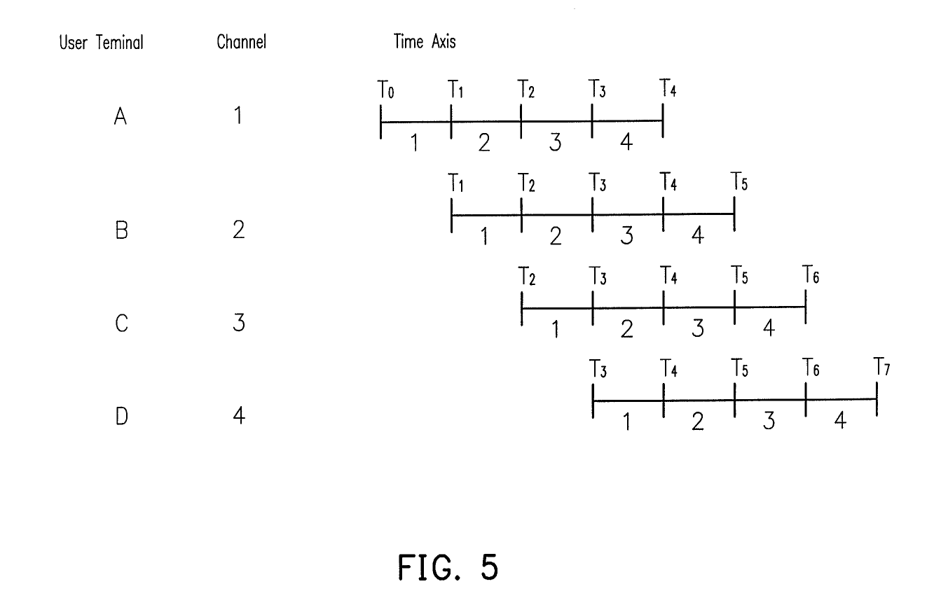

Referring to FIGS. 4 and 5, an embodiment of a video-on-demand method with reduced bandwidth of user network is illustrated. This method is applied to reduce the bandwidth used for multiple users to receive a common video information with a time difference between each other.

The video-on-demand method to reduce network bandwidth includes listing a information index (such as the program table) for the user terminals to select a desired video information (program content) in step s600. In step s602, the user terminal can then select the required video information among the information index.

In step s604, whether the second user terminal selects a video information the same as that selected by the first user terminal within a time interval. Assuming the first and second user terminals are A and B, if user terminals A and B select a common video information within a time interval, the channel of the communication network used by the user terminal A to receive the video information is inspected in step s608. Meanwhile, the receiving time that the user terminal A has spent on receiving this video information is also inspected.

In step s610, an unused channel in the communication network is used to output the front video information received by the user terminal A has received within the receiving time. Also, the user terminal B is noticed to record the rear video information that the user terminal A is currently receiving. Meanwhile, the user terminal B is noticed to switch to the unused channel to watch the selected common video information.

In FIG. 5, when the user terminal A is using a channel 1 to receive a film, and has watched the film from time T0 to T1 (that is, the first part of the film), the user terminal B selects this film to watch. If the film is transmitted to the user terminal B from the beginning thereof, too much bandwidth has to be consumed by this film. Therefore, the film is divided into a front part (the first part watched by the user terminal A from time T0 to T1) and a rear part (the following second, third and fourth parts that the user terminal A is to watch from time T1 to T4). When the user terminal A watches the rear part of the film after time T1, the user terminal B records the rear parts watched by the user terminal A from time T1 to T4 at the same time. Meanwhile, the video server uses an unused channel to output the front part of the film from T0 to T1 to the user terminal B.

In step s612, whether the front part of the film has been broadcast at the user terminal B is determined. If yes, the recorded rear part of the film is continuously broadcast in step s614. That is, the second, third and fourth parts of the film are broadcast. Otherwise, the first part of the film is continuously broadcast continuously in step s613.

The above example is further used to explain the method to reduce network bandwidth. Assuming that four user terminals select the same film to watch within a time interval, for example, from time T1 to T4. In the invention, other user terminals (that is, user terminals B, C and D) record the parts that the user terminal A has not watched first. Other channels (that is, channels 2, 3, 4) outputs the part that the user terminal A has broadcast. Therefore, the parts recorded in the user terminals B, C and D do not occupy the network bandwidth. In this example, if the conventional method is used, the bandwidth of 230400 Mbits will be occupied within time T0 to T7. In the invention, only 4*60*60*(4+1+2+3)=144000 Mbits of bandwidth is occupied (that is, the first user terminal occupies 4 hours, the rest of them occupy 1 hour, 2 hours and 3 hours). A bandwidth of 86400 Mbits is saved.

According to the above, the invention is advantageous for other user terminals to continuously use the stored rear part of the video information when the front part of the video information received by the first terminal within a time interval is received. The occupied bandwidth can thus be released in advance to reduce the consumption of bandwidth. The transmission load of the video-on-demand system is decreased, and the transmission speed of the system is enhanced.

Other embodiments of the invention will appear to those skilled in the art from consideration of the specification and practice of the invention disclosed herein. The above stated descriptions and statements are meant to be of a explanatory nature only and are not bound or restricted by the limited definition as claimed. It is intended that the specification and examples to be considered as exemplary only and within the truescope and spirit of the invention as indicated by the following below claims.

What is claimed is:

1. A video-on-demand method to reduce a network bandwidth used thereby, applied to reduce a bandwidth used for a plurality of user terminals to receive a common video information, wherein the user terminals receive the common video information with a time difference from each other, the method comprising of:
determining whether a second and a second user terminals select the common video information within the time difference;
inspecting a channel used by the first user terminal to receive the common video information and a receiving time to receive the common video when the first and second user terminals select the common video information within the time difference;
using an unused channel to output a front video information that the first user terminal has received, and recording a rear video information that the first user terminal is currently receiving at the same time; and
continuously receiving the recorded rear video information after the second user terminal has received the front video information.

2. The method according to claim 1, including using a cable television video-on-demand system to perform the video-on-demand method.

3. The method according to claim 1, including using a computer network video-on-demand system to perform the video-on-demand method.

4. The method according to claim 1, including using an intermediate video-on-demand system to perform the video-on-demand method

5. The method according to claim 1, wherein the unused channel is selected to output the video information directly if the second user terminal does not select a common video information as the first user terminal.

6. The method according to claim 1, wherein the video information includes video and audio information.

7. The method according to claim 1, further comprising of:
listing an information index; and
allowing the user terminals to select the required video information among the information index.

8. A video-on-demand system to reduce network bandwidth use thereby, applying to reduce bandwidth use for a plurality of user terminals to receive a common video information with a time interval from each other, wherein the time interval indicates that a second user terminal starts receiving a video information before a first user terminal finishes receiving the video information, the system comprising:
a video server, to determine whether the user terminals receive the common video information within the time interval;
a display installed at each of the user terminals to output the video information selected by the user terminal; and
a set top box installed at each of the user terminals and connected to the display and the video server via a communication network, each of the set top boxes further comprising a plurality of tuners, wherein
when the first and second user terminals receive the video information within the time interval, the set top box of the second user terminal starts storing a rear video information that the first user terminal is currently receiving via a first tuner, and the video server outputs a front video information that the first user terminal has received within the time interval to the second user terminal via a second tuner, so that the set top box of the second user terminal continuously outputting the stored rear video information to the display after outputting the front video information thereto.

9. The system according to claim 8, wherein each of the set top boxes further comprises of:
a row unit, connected to the video server via the communication network and including the tuners to divide the video information transmitted through the network into the front video information and the rear video information;
a process unit, connected to the row unit to output the front video information and to output the rear video information, wherein the stored rear video information is continuously transmitted before the front video information has been transmitted; and
a display unit, connected to the process unit and the display to output one of the front and rear video information to the display.

10. The system according to claim 9, wherein the process unit comprises:
a storage unit, connected to the row unit to store the rear video information transmitted by the first tuner; and
a decode unit, connected to the row unit, the storage unit and the display unit to decode and output the front and rear video information to the display unit.

11. The system according to claim 8, wherein the display includes a television.

12. The system according to claim 8, wherein the display includes a computer system.

13. The system according to claim 8, wherein the video-on-demand system includes a cable television video-demand system.

14. The system according to claim 8, wherein the video-on-demand system includes a computer network video-demand system.

15. The system according to claim 8, wherein the video-on-demand system includes an intermediate video-demand system.

16. The system according to claim 8, wherein the video information comprises video and audio information.

17. The system according to claim 8, wherein the communication network comprises an analog network.

18. The system according to claim 8, wherein the communication network comprises a digital network.
